(19) United States
(12) Patent Application Publication
(10) Pub. No.: US 2008/0081489 A1
(43) Pub. Date: Apr. 3, 2008

(54) Reliable land grid array socket loading device

(76) Inventors: Mike G. MacGregor, Portland, OR (US); Kazimierz A. Kozyra, Olympia, WA (US); Tod Byquist, Tukwila, WA (US)

Correspondence Address: INTEL/BLAKELY, 1279 OAKMEAD PARKWAY, SUNNYVALE, CA, 94085-4040, US

(21) Appl. No.: 11/541,714

(22) Filed: Sep. 29, 2006

(51) Int. Cl. H01R 12/00

(52) U.S. Cl. 439/71

(57) ABSTRACT

An apparatus for receiving and securing a processor on a mainboard in a computer system. The apparatus includes a socket and socket loading mechanism for a land grid array. The apparatus provides a load distribution mechanism to dissipate tensile and shearing forces at the corner of the socket to protect a solder ball grid array. This improves the durability of the solder ball grid array and increases the power of the processors that may be supported by the socket.

### BACKGROUND

1. Field of the Invention

The embodiments of the invention relate to a method and apparatus for coupling an integrated circuit with a circuit board. Specifically, the method and apparatus provide a socket and socket loading mechanism for coupling a land grid array package to a printed circuit board.

2. Background

Central processing units and similar integrated circuits communicate with other components of a computer system over a printed circuit board that is typically referred to as a mainboard or motherboard. Central processing units and similar processors are typically coupled to the mainboard through a socket. The socket serves as an interface for the mainboard and central processing units. The socket aligns the interconnects of the central processing unit and the mainboard. The socket is coupled with a socket loading mechanism that electrically requests the central processing unit to the mainboard.

One type of socket connection is referred to as a land grid array type socket. A land is a contact pad on the bottom of the central processing unit that forms an interconnect with a pin or similar structure on the socket or mainboard. The lands on a central processing unit may be arranged as a grid array. The pins of the mainboard extend through the socket to contact the lands. The pins are soldered to the circuit paths of the mainboard using a solder ball grid array. The solder ball grid array is an array of solder balls on the mainboard, each corresponding to a separate circuit path. During assembly a socket is placed over the ball grid array and the solder ball grid array is reflowed such that each ball becomes coupled to a pin within the socket and the socket is thereby attached to the mainboard.

Maintaining electrical contact between the pins of the socket and the lands of the central processing unit requires that a requisite amount of compressive force is applied to the processor and socket, such that each of the processor pads and the socket pins electrically connects. The socket loading mechanism is responsible for generating and maintaining this force as well as securing the central processing unit to the mainboard. When the central processing unit is seated in the socket a load plate exerts force against the central processing unit generated by a lever attached to the load plate at one end together with hinge constraints at the other end, thereby securing the central processing unit in the socket and maintaining electrical contact.

However, as bandwidth requirements between the central processing unit and the mainboard are increasing over time, the number of lands and socket pin increase and consequently the total amount of force that is required to maintain each parallel electrical connection increases. Current socket designs are unable to evenly apply the requisite pressure to the central processing unit and the socket, when large land and pin counts are contemplated. The increased force and reactant force cause disproportionate stress to the corners of the ball grid array and socket decreasing the reliability of the socket. This reduction in reliability is due to high tensile and shear loads to the ball grid array at the corners of the socket. These loads may cause crack growth that may be further exacerbated by temperature cycling of the central processing unit during use, mismatched coefficients of thermal expansion of interconnect materials, and shock and vibration from the shipping and handling of the computer system. To counteract such damage an expensive backing plate must be used.

In addition, larger processors typically require larger thermal solutions. These thermal solutions are coupled to the socket through the central processing unit. The central processing unit must maintain a thermal interface with the thermal solution to dissipate heat at the same time that the central processing unit maintains an electrical interface with the socket. The thermal interface reliability is attained via another compressive static load that interacts with the static load generated by the loading mechanism. The larger the processor, the larger the needed thermal solution and the static compressive force required to maintain thermal reliability.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1A is diagram of one embodiment of a land grid array socket and socket loading mechanism.

FIG. 1B is a diagram of one embodiment of the distribution of a load across the socket and socket loading mechanism.

FIG. 2 is diagram of one embodiment of a land grid array socket and socket loading mechanism with integrally formed fasteners.

FIG. 3 is a diagram of one embodiment of a land grid array socket and socket loading mechanism with a cam plate.

FIG. 4 is a diagram of one embodiment of a land grid array socket and socket loading mechanism with a back plate.

FIG. 5 is a diagram of one embodiment of a land grid array socket and socket loading mechanism with fasteners formed integrally with a socket stiffener frame.

FIG. 6 is a diagram of one embodiment of a land grid array socket and socket loading mechanism for large contact arrays or double compression sockets.

FIG. 7A is a graph showing the load on a ball grid array for a conventional land grid array socket.

FIG. 7B is a graph showing the load on a ball grid array for one embodiment of a land grid array socket.

FIG. 7C is a graph showing the comparative maximum tension load of a conventional land grid array socket and one embodiment of a land grid array socket.

FIG. 8 is a flowchart of one embodiment of a process for assembling a socket.

FIG. 9A is a diagram of one embodiment of a land grid array socket and socket loading mechanism with add-on clips.

FIG. 9B is a diagram of one embodiment of a land grid array socket and socket loading mechanism with add-on components.

### DETAILED DESCRIPTION

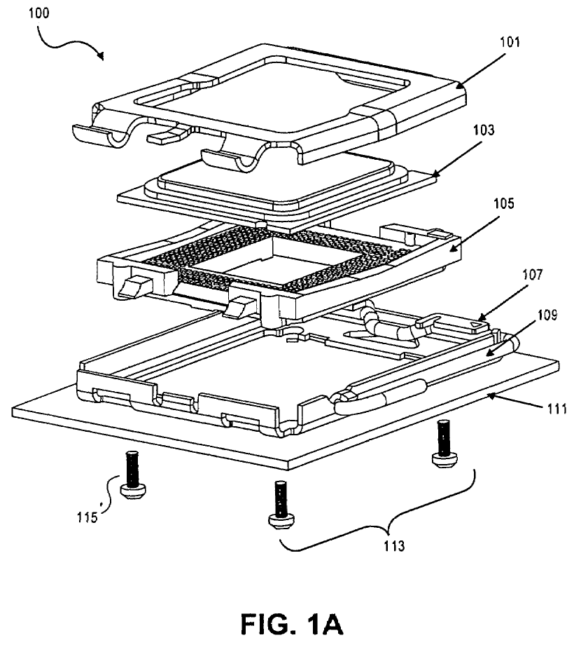

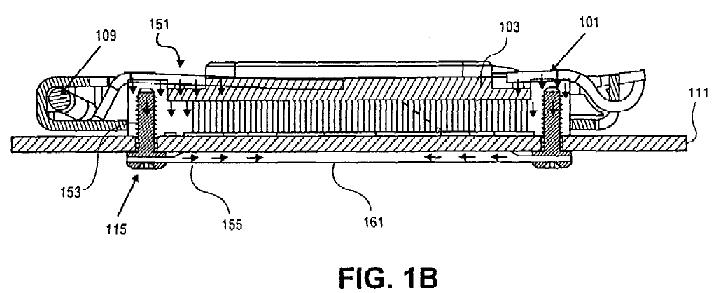

FIG. 1 is diagram of one embodiment of a land grid array socket. In one embodiment, the land grid array (LGA) socket 100 may be attached to a circuit board 111. The circuit board 111 may be any type of circuit board such as printed circuit board or similar substrate for attaching an integrated circuit and similar components. The circuit board 111 may be a mainboard, a peripheral component card or similar type of board. The circuit board 111 may be utilized in a computer system (e.g., a desktop system, laptop, server or similar system), s console device, a consumer electronic device or similar device.

In one embodiment, the LGA socket and accompanying socket loading mechanism or holding mechanism may include a load plate 101, a socket body 105, a socket stiffener frame 107, a load lever 109 and a load distribution mechanism 113. The socket body 105 is the portion of the socket in which an integrated circuit (IC) 103 is seated. Any type of IC may be designed to be placed in the LGA socket including central processing units, graphics processors, network processors, combined processor and chipset packages and similar integrated circuits. The socket body 105 may be formed from any non conductive form of plastic, resin or other material. The socket body 105 may have any size and dimensions. The number of spaces for contacts defined by the socket body 105 may depend on the number of lands for the associated IC. Any number of lands and contacts may be supported including over 900 lands. The size and shape of the socket body 105 may be designed to match the size and shape of the associated IC including accommodating more than 900 pins to coupled with the 900 lands.

The socket body 105 defines a space for a set of contacts that are to be electrically in communication with the LGA of the IC. These contacts may be a set of cantilevered springs or similar contact structures or mechanisms. The socket contacts are placed in electrical communication with the lands of the IC by application of pressure against the IC to maintain physical and electrical contact between the contact structures and the lands. The contact structures are also in electrical communication with a ball grid array on the circuit board 111. Each contact structure may be attached to a separate ball. The solder balls of the ball grid array are attached to the contact structure by a reflow process that also consequently attaches the socket body 105 to the circuit board 111. In other embodiments, other methods of attachment and attachment structures may be utilized. For example, in place of a solder ball grid array socket with double compression contacts may be utilized.

The socket body 105 may be supported by a socket stiffener frame 107. The socket stiffener frame 107 provides support to the socket body 105 and attachment points for other components such as the load lever 109 and load plate 101. The load plate 101 may be coupled with the socket stiffener frame 107 through a hinge or similar feature that may be a part of a load path between the load plate 101 and the socket stiffener frame 107. The socket stiffener frame 107 may be connected to the socket body 105 by interlocking parts or similar coupling mechanism. The socket stiffener frame 107 may be metal, plastic or similar material. In one embodiment, the socket stiffener frame 107 is made from reinforced steel. The socket stiffener frame 107 may have dimensions that match the socket body 105 to form a perimeter around the socket body 105.

The socket stiffener frame 107 may define a coupling mechanism for the load lever 109 and load plate 101. A portion of the load lever 109 may be disposed in a set of channels within the stiffener frame 107 to allow rotation of the load lever 109. Rotating the load lever 109 may generate a force on the load plate 101. The load lever 109 may employ a mechanical advantage of 20:1 or greater to generate the force needed to lock the load plate 101 into position and hold the lands of the IC 103 in contact with the contacts of the socket body 105. With an applied force of four pounds or less the load lever may generate 80 to over 120 pounds of force through the load plate 101. The load lever 109 may be made from a rigid material such as steel or similar materials.

In one embodiment, a load plate 101 is coupled by a hinge or similar feature to the socket stiffener 107 to rotate to a closed position. In the closed position an arm of the load lever 109 may exert pressure on the load plate to hold the IC 103 in place and in contact with the contacts in the socket body 105. The load plate 101 may define an open top portion to allow an integrated heat spreader on the IC package 103 to protrude past the top surface of the load plate 101. The load plate 101 may be formed with a slight bend in the plate to compensate for the pressure exerted by the load lever 109 such that the load plate 101 when acted upon by the load lever 109 is substantially flat as it reacts against the central processing unit and hinge interface. The load plate 101 may be formed from a rigid material such as steel or a similar material.

In one embodiment, the IC package 103 may be loaded into the socket body 105 and held in place by the load plate 101 and load lever 109. The IC package 103 may be made of any material or composite thereof including a plastic, ceramic, resin or similar material. The top of the IC package 103 may be an integrated heat spreader that is designed to allow the dissemination of heat through the top of the package to prevent the IC from overheating. The IC package 103 may have any shape or dimensions. The size of the IC package 103 is often based on the number of lands needed for the IC. ICs with large data paths such as 64-bit or 128-bit processors have larger land counts and require larger footprints.

A thermal solution (not shown) may be attached to the socket stiffener frame 107 or other portion of the socket, socket loading mechanism or the circuit board 111. The thermal solution may be a heat sink, a fan or combination thereof. The thermal solution may be formed from copper, aluminum or other heat dissipating material. The thermal solution contributes to the reliability problems of a socket. The thermal solution may cause addition stress on the socket during attachment of the thermal solution and during movement of the combined socket and thermal solution. The thermal solution may be attached to the socket stiffener frame 107 by a latching mechanism that exerts a force to hold the thermal solution in place that is reacted by the socket stiffener frame 111. This causes additional uneven stress on the solder ball grid array that is counteracted by the load distribution mechanism 113.

In one embodiment, the socket body 105 may be further reinforced to distribute loads applied to the socket by a load distribution mechanism 113. The load distribution mechanism 113 may be a set of axial members 115, such as screws, posts or similar members, hooks, latches or similar coupling mechanisms. The load distribution mechanism 113 may attach to a socket body 105 through the circuit board 111. The load distribution mechanism 113 may be attached to the socket body 105 at points of higher or uneven stress on the socket. For example, a set of four screws 115 may be placed at the corners of the socket to receive load exerted by the load lever 109 and load plate 101 on the IC chip package 103 and consequently alleviate tensile and shearing load on the solder ball grid array. The load distribution mechanisms 113 may be made from any material including steel, plastic or similar materials.

FIG. 1B is a diagram of a cross section one embodiment of land grid array socket and loading mechanism. The diagram depicts the distribution of load applied to the socket and IC package 103 by the socket load mechanism. The load lever 109 and load plate 101 apply a load 251 (depicted by a small force arrow) to the socket body 105 and IC package 103. A portion of this load 253 is distributed by an axial member 115 or similar component of a load distribution mechanism. This distribution of the load through the axial member takes pressure off the solder ball grid array that couples the socket body 105 to the circuit board 111.

In embodiments to be discussed at further length below, the load distribution mechanism may include a back plate 261 or similar component. The back plate 261 further distributes a portion of the load 255 and evens out the distribution of the load across the surface of the circuit board 111.

In addition the load distribution mechanism may react the load and create compressive forces on the solder ball grid array thereby reinforcing the array and diminishing the effects of tensile or shearing load or other forces such as environmental stresses on the solder ball grid array.

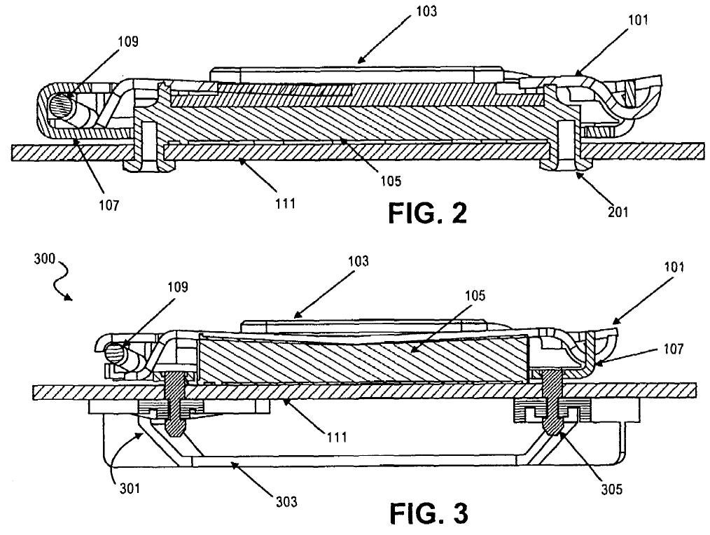

FIG. 2 is diagram of one embodiment of a land grid array socket and socket loading mechanism with an integrally formed load distribution mechanism. In one embodiment, the load distribution mechanism 201 may be formed as an integral part of a socket body 105. The socket body 105 may be formed from plastic or similar material capable of forming a set of posts or similar load distribution mechanism 201. In one embodiment, the load distribution mechanism 201 of the socket body 105 may be combined with the load distribution mechanism by extrusion, heat staking, ultrasonic welding or similar process. The socket body 105 may be attached to the circuit board 111 at the time it is placed on the circuit board. The load distribution mechanism may couple the socket body 105 to the circuit board 111 by a form fit, snap fit or similar attachment mechanism. The socket body 105 may also be attached by a reflow process.

FIG. 3 is a diagram of one embodiment of a land grid array socket, socket loading mechanism and load distribution mechanism with a cam plate. In one embodiment, a LGA socket and load distribution mechanism may include a cam plate 303. A cam plate 303 may be attached to the socket 300 as a part of a load distribution mechanism 301. The load distribution mechanism 301 may include a complementary part to the cam plate 303 or similar attachment mechanism to secure the cam plate 303. In one embodiment, the load distribution mechanism 301 includes a post 305 with a narrowed body and enlarged head portion. The post 305 may be placed through an opening in the came plate 303 to interlock the two components.

The cam plate 303 may have any shape or size. The cam plate 303 may have a portion that abuts the back plane of the circuit board 111. The cam plate 303 further distributes the load received from the posts 205 or similar axial members across the back of the circuit board 111 and provides support to the posts 305 or similar axial members of the load distribution mechanism 301. The cam plate 303 may be formed from any material including steel, plastic or other rigid materials. The cam plate 303 may have any shape or dimensions sufficient to couple with each of the axial members of the load distribution mechanism 301.

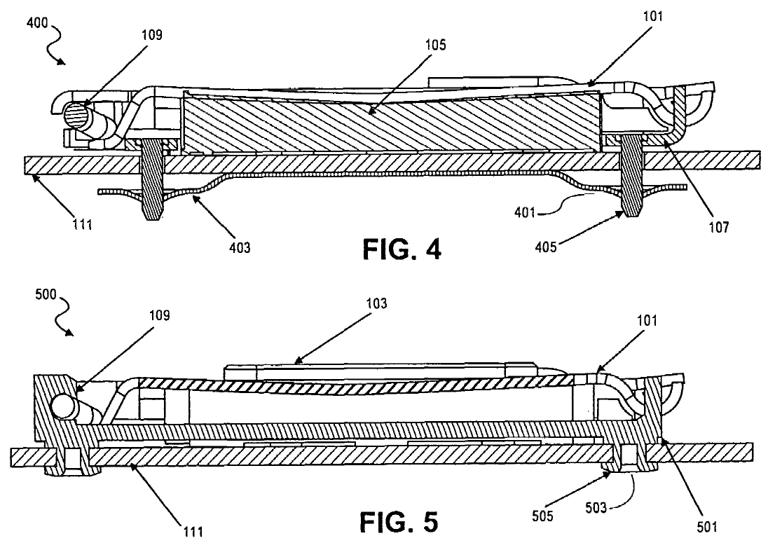

FIG. 4 is a diagram of one embodiment of a land grid array socket with a load distribution mechanism including a back plate. In one embodiment, an LGA socket may include a load distribution mechanism 401 with a back plate 403. A back plate 403 may be attached to the socket 400 through the circuit board 111 and socket body 105 by an axial member 405 (e.g., posts, screws or similar components) or similar attachment mechanism. The axial member 405 may define a complementary part to the back plate 403 or may be similarly attached to the back plate 403. In one embodiment, the load distribution mechanism 401 includes a post 405 with a shape and size to fit in a complementary hole in the back plate 403. The posts 405 may be placed through an opening in the back plate 403 to interlock the two components. The back plate 403 may be attached by any type of coupling mechanism including form fit, snap fit, interlocking components or similar attachment mechanisms.

The back plate 403 may have any shape or size. The back plate 403 may have a portion that abuts the back plane of the circuit board 111. The back plate 403 further distributes the load across the back of the circuit board 111 and provides support to the axial members 405 and other components of the load distribution mechanism 401. The back plate 403 may be formed from any material including steel, plastic or other rigid materials.

FIG. 5 is a diagram of one embodiment of a land grid array socket and socket loading mechanism with fasteners formed integrally with a socket stiffener frame. In one embodiment, a socket stiffening frame 501 may provide additional support to the socket body 105 and the solder ball grid array. The socket stiffening frame 501 may be formed integrally with a load distribution mechanism 503. The load distribution mechanisms 503 may include a set of posts 503, fasteners, latches or similar coupling mechanisms. The load distribution mechanism 503 may be formed integrally with the socket stiffener frame 501, by heat staking, ultrasonic welding or similar process. The socket stiffening frame 501 may be attached directly to the circuit board 111 to assist in distributing the load evenly across the circuit board 111 and the ball grid array. The load distribution mechanisms 503 may be positioned at points of uneven load or high stress on the ball grid. The load distribution mechanism 503 may provide an attachment mechanism for the load stiffening frame 501 and secure it to the circuit board 111 by form fit, snap fit, latches or similar coupling mechanism.

In one embodiment, the socket stiffening frame 501 may be formed from plastic, resins or similar materials. The socket stiffening frame 501 may be placed on the circuit board 111 during the assembly process before or after the socket body 105. The socket body 105 may interlock with the socket stiffening frame 501 to allow the load to pass from the socket body 105 to the socket stiffening frame 501 and then to the load distribution mechanism 503.

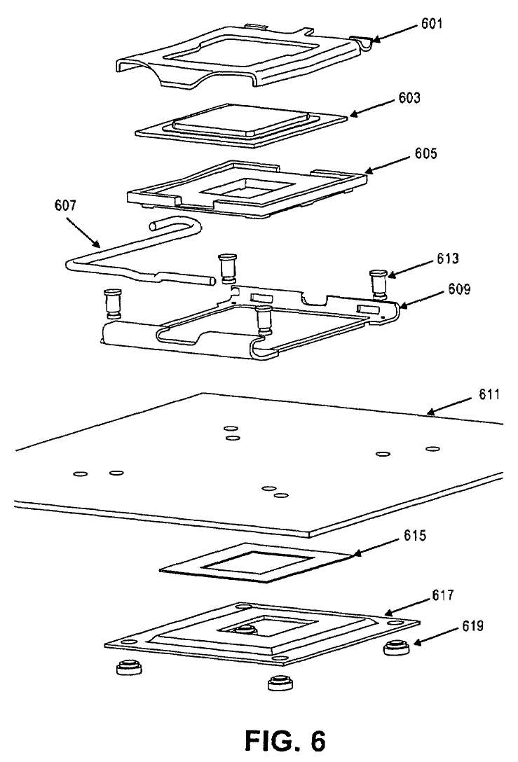

FIG. 6 is a diagram of one embodiment of a land grid array for large contact arrays and double compression arrays. In one embodiment, a socket and socket loading mechanism may include a load plate 601, socket body 605, a socket load frame 609, insulator 615, back plate 617, fasteners 613 and 619 that form a load distribution mechanism and similar components.

In one embodiment, the socket load frame 609 serves as an interface and load reaction member for the load plate 601 and load lever 607. The socket load frame 609 transfers load from the lever 607 and load plate 601 to a socket body 605 and load distribution mechanism including a back plate 617, which reacts the load evenly across the back side of the circuit board 611.

In one embodiment, the socket load frame 609 may not have a structural interface to the socket body 605 and references the sides of the socket body 6905. The socket load frame 609 may be made from metal, plastic or a combination thereof. The socket load frame 609 forms a perimeter around the socket body 605. The socket load frame 609 and socket body 605 have dimensions that are based on the footprint of the IC to be received. In another embodiment, the socket load frame 609 may engage the socket body 605.

In one embodiment, a load plate 601 rotates about a hinge line that interfaces the socket load frame 609 and contacts the IC 603. The load plate 601 may be activated by the load lever 607 opposite the hinge line. The load plate 601 itself may generate approximately a 2:1 mechanical load advantage from the load lever interface to the integrated heat spreader interface. The load plate 601 becomes flat and stays below the top surface of the IC that protrudes through the opening in the load plate 601.

In one embodiment, the load lever 607 has an offset in the wire such that rotation of the lever 607 will generate a load on the load plate 601. The load lever 607 has approximately a 20:1 mechanical advantage. The load lever 607 may be activated by a force of approximately four pounds or less. The load lever a 607 and load plate 601, combined, may exert a force of 120 pounds or more in response on the IC package 603 and the socket body 605. After the load lever 607 is rotated it may be retained by a catch on the socket load frame 609.

In one embodiment, the back plate 617 of the load distribution mechanism attaches to the socket load frame 609 through holes in the circuit board 611 and a set of fasteners 613, 619. The back plate 617 distributes the reaction load from the load plate 609 evenly across the body of the socket. The back plate 617 may be a sub-assembly of a primary plate 617, a set of axial members for carrying a load from the socket load frame, such as screws 613 and nuts 619 and an insulative material 615 between the back plate 617 and the circuit board 611 to prevent electrical shorting.

In one embodiment, this configuration of a socket, socket loading mechanism and load distribution mechanism may be support the seating of a IC package with over 1000 contacts by generating sufficient force through the load plate (e.g., over 120 pounds) to maintain electrical contact between the lands of the IC package 603 with the interconnects of the socket body 605. Further, the socket body 605 may have single compression interconnect, that is interconnects that are solder into a solder ball grid array. In another embodiment, the socket may be a double compression socket where a solder ball grid array is not employed to electrically couple the interconnects of the socket body 605 with the circuit paths of the circuit board 611. Instead, a set of cantilevered springs or similar compression mechanism may maintain contact between the socket and the circuit board. Use of a double compression interface requires a greater level of pressure to be applied to the socket body 605 and the IC package 603. The load distribution mechanism supports this added pressure.

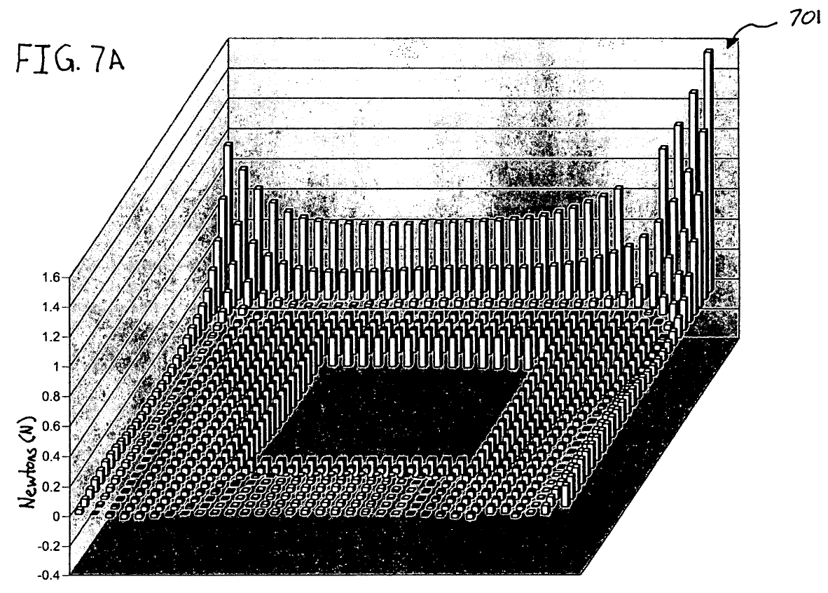

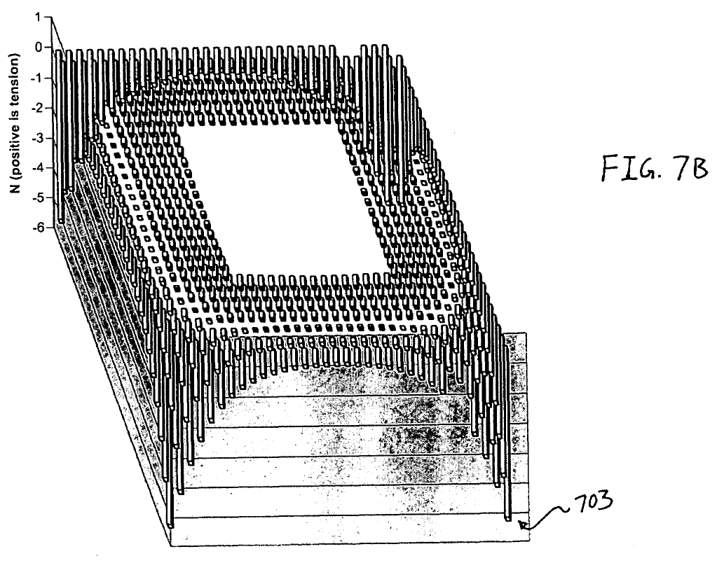

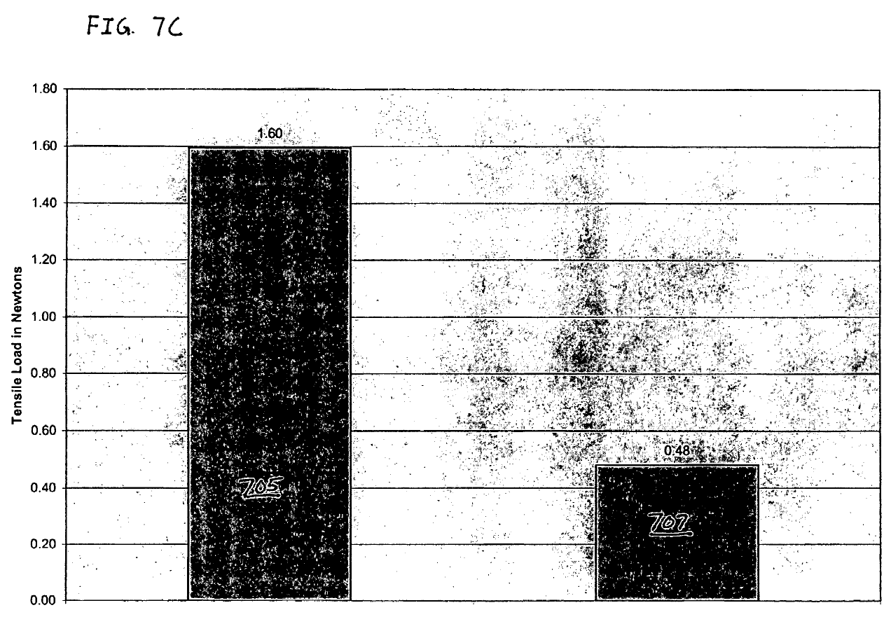

FIG. 7A is a graph showing the load on a ball grid array for a conventional land grid array socket. The graph shows a high tension loading of the corners of the ball grid array 701 during socket loading. The tension loading at a corner may be 1.5 Newtons or greater. Socket loading is the loading due to the placement of the IC package into the LGA socket. The load is generated by the application of force on the load lever which is mechanically transformed into a larger force on the load plate. This loading does not take into account loading from installation of a thermal solution or environmental loading such as shipping or similar forces.

The high tensile loading on the corners of the solder ball grid array may lead to cracking of the solder balls. This problem may be further exacerbated by the temperature cycling of the processor from normal operation as well as environmental, shipping, thermal solution attachment and similar events and conditions. These factors can lead to a failure of the solder ball grid array and thus the socket interface prior to the end of the 7 year life intended life span of the socket.

This failure risk must be mitigated by restricting the temperature cycling of the IC package in the socket or reducing the tension and/or shear loading on the solder ball grid array. The IC package must be kept below a temperature level of 74 degrees Centigrade. This temperature limitation restricts the performance of the IC in the socket. More powerful ICs such as central processing units and graphics processors consume large amounts of energy in a densely populated chip resulting in high temperatures. The higher the operating speed and processing power of the processor the higher the temperature generated. Thus, a temperature restriction directly translates into a processor processing power restriction.

FIG. 7B is a graph showing the load on a solder ball grid array for one embodiment of a land grid array socket. The graph shows the high compression forces 703 that have replaced the high tension forces at the corners of the solder ball grid array for embodiments of the present invention. This is a result of the transfer of load via the load distribution mechanisms described herein. Each of the points of compression may correspond to a load distribution mechanism. This compression is not likely to result in damage or decreased reliability of the ball grid array or the socket. In fact, it provides support and reinforces the solder balls in the grid array.

As a result, a processor in the socket may operate at temperatures in excess of 74 degrees Centigrade without significant risk of damaging the solder ball grid array or the failure of the socket. This allows the socket to support more powerful processors that operate at higher speeds, consume more power and have larger numbers of lands.

FIG. 7C is a graph showing the comparative maximum tension load of a conventional land grid array socket and one embodiment of a land grid array socket. A first bar 705 represents the maximum tension loads of conventional land grid array sockets. The second bar 707 represents the maximum tension loads of at least one embodiment of the land grid array socket. The conventional land grid array sockets have a maximum tension load of 1.6 Newtons while the embodiment has a maximum tension load of 0.48 Newtons.

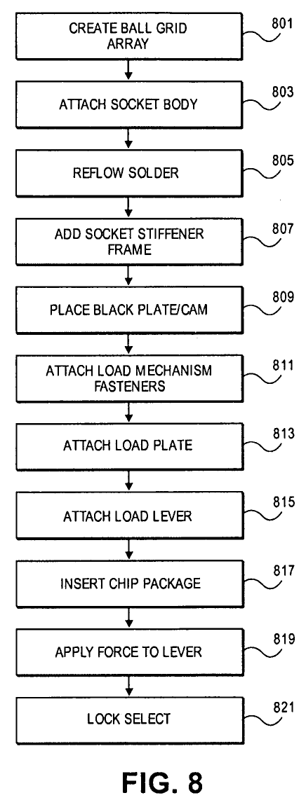

FIG. 8 is a flowchart of one embodiment of a process for assembling an embodiment of a land grid array socket and socket loading mechanism. In one embodiment, the assembly process of the socket may begin with the preparation of the circuit board for installation. The circuit paths and other components of the circuit board may be prepared in advance of the assembly of the socket. In another embodiment, the socket assembly may take place during or after the preparation of other circuit board components.

In one embodiment, the ball grid array may be placed on the circuit board (block 801). The ball grid array may be placed over a set of circuit path endpoints or similarly placed. The solder ball grid array may be placed by heating of solder to create a set of solder balls using any technique for creating a solder ball grid array. In one embodiment, after the solder ball grid array has been prepared a socket body may be placed on the ball grid array (block 803). The socket is placed to align the contacts in the socket body with the balls of the solder ball grid array. Each contact corresponds to a separate data or control signal path from the circuit board to the IC. The socket body may also be inserted into holes or similarly attached to the circuit board if it has integrated or other attachment mechanisms, e.g. a load distribution mechanism, that provide additional coupling mechanisms for the socket body and the circuit board. In another embodiment, a loading mechanism or similar attachment mechanism may not be utilized until later in the assembly process.

In one embodiment, after the socket body has been placed a reflow operation may be conducted (block 805). A reflow operation reheats or similarly causes the ball grid array to flow. Reflowing the ball grid array allows each ball in the grid array to attach to a contact in the socket. This also serves to attach the socket to the circuit board. The reflow process only heats the solder ball grid array sufficiently for it to couple to adjacent contacts in the socket and does not reflow the solder to the point that the individual balls may connect to one another. In another embodiment, the reflow process may not be utilized because the socket body is a double compression interface.

In one embodiment, after the reflow process has completed a socket stiffener may be added to the socket body (block 807). The socket stiffener may couple to the socket body using interlocking mechanisms or similar coupling mechanisms. In one embodiment, the socket stiffener frame may not directly attach to the circuit board. In another embodiment, the socket stiffener frame may include a set of load distribution mechanisms either integrally formed or attached to the frame. The load distribution mechanism may be used to mount the socket frame stiffener on the circuit board thereby providing additional support for the socket body and ball grid array.

In one embodiment, the load distribution mechanism may include a back plate or cam plate (block 809). After the socket body and socket stiffener are in place the cam plate or back plate may be positioned for attachment. Positioning the back plate or cam plate may include aligning holes or attachment mechanisms of the back plate or cam plate with corresponding holes or attachment mechanisms of the socket and circuit board. In an embodiment, where attachment mechanisms are integrally formed with the socket body or socket frame stiffener the back plate or cam plate may be directly attached to these structures.

In another embodiment, load distribution mechanism fasteners such as a set of posts, screws, dowels or similar structures may be used to fix the back plate or cam plate to the socket or socket stiffener (block 811). In other embodiments, without a back plate or cam plate the load distribution mechanism fasteners may be used to reinforce the connection of the socket body or socket stiffener frame and relieve high tension spots in the solder ball grid array caused by the assembly, loading, temperature cycling, shipping or similar process related to the loading of the socket. The load distribution mechanism may be attached by complementary threading, interlocking parts, form fit, snap fit or similar attachment mechanisms.

In one embodiment, after the socket body and socket stiffening frame have been seated and the load distribution mechanism is in place, the load plate may be attached to the socket (block 813). The load plate may be attached as a loose hinge, set of interlocking parts or similarly attached (block 813). The load plate may rotate in relation with the socket body and socket stiffener frame. The rotating mechanism may attach the load plate to the socket or socket stiffener frame at one edge of the plate. The load plate may also interlock or engage the socket along other edges.

A load lever may be attached to the socket stiffener frame by placement in a receiving channel defined by the socket stiffener frame and the load plate (block 815). The lever may be rotatably coupled to the socket stiffener and load plate. The lever may be used to exert a force on the load plate to secure the IC within the socket by applying sufficient pressure to the load plate. The lever may generate a 20:1 mechanical advantage for applying force to the load plate. This force secures the load plate in a closed position until the lever is lifted and releases the load plate allowing it to rotate freely. A load lever may engage a catch or similar mechanism in the closed socket position to maintain the closed lever position (block 821).

In one embodiment, the socket assembly may be considered complete at this stage as each of the primary components has been introduced and added to the socket. A socket and circuit board may be shipped in this state or purchased in this state. Subsequently, an IC may be loaded by a user or consumer.

In another embodiment, the IC may be loaded as part of the assembly process (block 817). The IC may be placed in the socket body. The socket body may have a shape complementary to the IC to ensure that the lands of the IC properly align with the contacts of the socket. The IC and socket may have shapes that require that the IC have a particular orientation to the socket. Once the IC is properly seated in the socket the load plate may be rotated to cover the IC and the lever may be actuated to apply pressure to the load plate (block 819). When the lever is fully actuated the IC is locked into place and the lever may be held into place by a catch or similar mechanism (block 821).

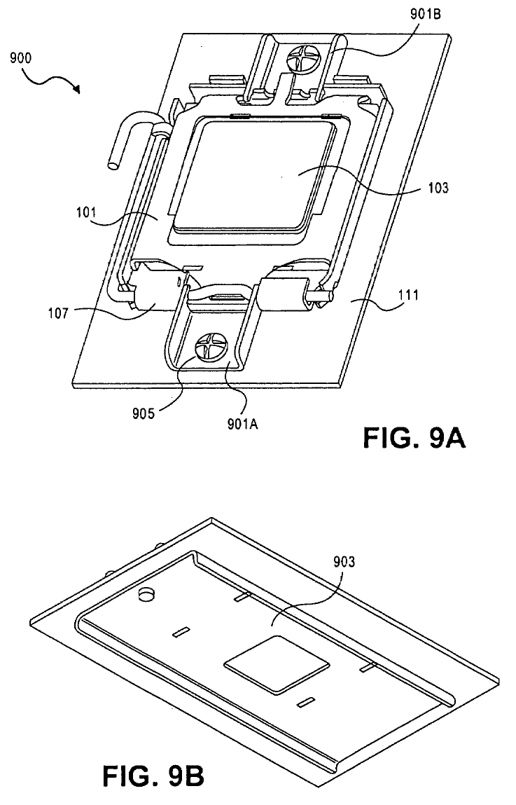

FIG. 9A is a diagram of one embodiment of a land grid array socket with a load distribution mechanism including add-on clips. In one embodiment, the socket and socket loading mechanism may support add-on components that attach to the socket or socket loading mechanism to improve the reliability of the socket for high performance ICs where end-user operating temperatures may be a cause of failure for the IC. If lower end ICs with lower operating temperatures are used then the add-on components do not need to be used. This approach allows for less expensive versions of the socket without add-ons to be used for certain ICs with minimal requirements and more expensive versions with add-on components to be used for high performance ICs, thereby providing an incremental approach to securing the IC and supporting high performance ICs.

In one embodiment, a load distribution mechanism may include a set of clips 901A, 901B that may be attached to the socket stiffening frame 107, socket body or similar component of the socket. The add-on part may be any number of clips 901A, 901B, latches, clamps or similar structures. These structures may be coupled to the circuit board 111 by a set of fasteners 905 that are a part of the load distribution mechanism. The fasteners 905 of load distribution mechanism may be posts, screws, dowels or similar mechanisms to attach the clips 901A, 901B and the socket to the circuit board 111. The add-on component may form fit, snap fit, latch or similarly couple to the socket frame 111, socket body or similar component of the socket 900.

The add-on components may be used to incrementally improve the reliability of the socket. Individual add-on components may be added to the socket for each desired increase in reliability or support for a next grade higher of IC. In another embodiment, the add-on components may be added incrementally in sets to improve reliability. For example, a set of two clips 901A, 901B may be added to the socket to improve reliability by one increment.

In one embodiment, the incremental load distribution mechanism may require that a circuit board support the add-on components by providing through holes and similar components for attaching the add-on components.

FIG. 9B is a diagram of one embodiment of a land grid array with add-on components. In one embodiment, the add-on components may include a back plate 903. The back plate 903 may provide a component into which other add-on components may be incrementally attached as part of the load distribution mechanism. In another embodiment, the back plate may be a standard component of the socket that enables add-on components to be used by providing a mounting structure to attach the add-on components of the load distribution mechanism.

In one embodiment, the assembly process may be automated by hardware devices. In another embodiment, these components may be implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the embodiments of the invention have been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. An apparatus comprising:
a load plate to apply a load to a chip package, the load plate including at least one hinge;
a socket body to receive a chip package;
a reactant frame to react the load from the load plate; and
a load distribution mechanism to distribute the load from the socket body and the reactant frame uniformly across an interconnect and to reduce tension or shear loading in the interconnect, wherein the load distribution mechanism is adapted to couple at least two components of the apparatus.

2. The apparatus of claim 1, wherein the load distribution mechanism further comprises:
a back plate to further distribute load across the back surface of a printed circuit board.

3. The apparatus of claim 1, further comprising:
a load lever to generate the load on the load plate if a force is exerted on the load lever.

4. The apparatus of claim 1, wherein the load distribution mechanism comprises:
at least one axial member to be disposed through a printed circuit board.

5. The apparatus of claim 1, wherein the load distribution mechanism comprises:
at least one axial member coupled to the socket body adjacent a corner of the socket body to reduce stress on a corner of the chip package.

6. The apparatus of claim 1, wherein the socket body includes over nine hundred contacts.

7. The apparatus of claim 1, wherein the socket body is coupled to a printed circuit board by a solder ball grid array.

8. The apparatus of claim 1, further comprising:
a cam plate to further distribute load across the back surface of a printed circuit board.

9. The apparatus of claim 1, wherein the load distribution mechanism diminishes interconnect failure caused by temperature cycling.

10. An apparatus comprising:
a holding mechanism to secure a chip package to a circuit board providing a first level of reliability in securing the chip package; and
a first removable component to combine with the holding mechanism to provide a second level of reliability in securing the chip package, wherein the first removable component is adapted to couple at least two units of the holding mechanism.

11. The apparatus of claim 10, further comprising:
a second removable component to combine with the holding mechanism to provide a third level of reliability in securing the chip package.

12. The apparatus of claim 10, wherein the holding mechanism is a land grid array socket.

13. The apparatus of claim 10, wherein the first removable component includes an axial member to be disposed through the circuit board.

14. The apparatus of claim 10, wherein the first removable component may be combined with the holding mechanism after the chip package is secured in the holding mechanism.

15. The apparatus of claim 10, wherein the first removable component combined with the holding mechanism distributes a load from the holding mechanism uniformly across an interconnect and reduces tension or shear loading in the interconnect for the chip package.

16. A system comprising:
a circuit board;
a graphics processor coupled to the circuit board; and
a processor coupling mechanism coupled to the circuit board, the processor coupling mechanism including,
a load plate to apply a load to a processor, the load plate including at least one hinge,
a socket body to receive a processor,
a reactant frame to react the load from the load plate; and
a load distribution mechanism to distribute the load from the socket body to distribute the load from the socket body and the reactant frame uniformly across an interconnect and to reduce tension or shear loading in the interconnect on a processor, wherein the load distribution mechanism is adapted to couple at least two components of the process coupling mechanism.

17. The system of claim 16, further comprising:
solder ball grid array coupled to a surface of the circuit board.

18. The system of claim 16, wherein the ball grid array includes at least nine hundred solder balls.

19. The system of claim 16, wherein the load distribution mechanism further comprises:
a back plate to further distribute load across the back surface of the circuit board.

20. The system of claim 16, wherein the processor coupling mechanism further comprises:
a removable coupling mechanism to secure the processor coupling mechanism to the printed circuit board and provide additional load distribution.

21. A method comprising:
placing a socket body on an interconnect;
placing a socket stiffener frame over the socket body;
attaching a load plate to the socket stiffener frame, the load plate including at least one hinge;
attaching a load lever to the socket stiffener frame; and
fastening the socket body to the printed circuit board with a load distribution mechanism to distribute a load from the socket body and socket stiffener frame uniformly across the interconnect and to reduce tension or shear loading in the interconnect, wherein the load distribution mechanism is adapted to couple at least two components, the at least two components comprising one of the socket body, the socket stiffener frame, and the load plate.

22. The method of claim 21, further comprising:
attaching a back plate to the load distribution mechanism to further diminish load or effects of temperature cycling on the interconnect.

23. The method of claim 21, further comprising:
inserting a chip package into the socket body; and
exerting a small force on the load lever to place a load greater than one hundred pounds on the load plate.

24. (canceled)

25. The method of claim 21, further comprising:
fastening at least one clip to the socket stiffener frame.

26. The method of claim 21, wherein the interconnect includes any one of a double compression array or a solder ball grid array.

27. The apparatus of claim 1, wherein the load distribution mechanism is integral with the socket body.
